(19) United States
(12) Patent Application Publication
(10) Pub. No.: US 2019/0005447 A1
(43) Pub. Date: Jan. 3, 2019

(54) INTEGRATED FREIGHT REMEDIATION SERVICE NETWORK PLATFORM

(71) Applicant: WeFixFreight.Com LLC, Frederick, MD (US)

(72) Inventors: William T. Carlin, Frederick, MD (US); Andrew Hill, Frederick, MD (US)

(73) Assignee: WeFixFreight.Com LLC, Frederick, MD (US)

(21) Appl. No.: 15/857,479

(22) Filed: Dec. 28, 2017

Related U.S. Application Data
(60) Provisional application No. 62/439,716, filed on Dec. 28, 2016.

(51) Int. Cl. G06Q 10/08

(52) U.S. Cl. CPC G06Q 10/0834; G06Q 10/08355; G06Q 10/0838; G06Q 10/08345

(57) ABSTRACT

Disclosed is a system for on-demand provisioning of freight remediation services including freight rework, repacking, cross-docking and redelivery. The system includes a data store having therein a freight remediation case database. A computer processor coupled to the data store and in communication through the Internet with a user device is programmed, upon receiving requests from the user device, to serve the user device data comprising instructions for populating one or more freight remediation case input pages and instructions for populating a dashboard page. The freight remediation case input pages include a user interface that prompts the user to create a new freight, enter or select a location for the new freight, select a facility for remediation of the new freight, select a cross-dock option for the new freight, enter or select a redelivery facility for the new freight, and open a case by accepting terms for freight remediation service. By remediating damaged loads, the presently disclosed system and method reduces claims processing and insurance expense for third-party logistics companies and shippers. The dashboard page includes a user interface that displays to the user data associated with one or more open cases.

This application is a non-provisional of and claims priority to U.S. Provisional Patent Application No. 62/439,716 filed Dec. 28, 2016, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present invention relates in general to the field of systems for freight remediation, and in particular to a network platform for conducting freight remediation.

### BACKGROUND

When freight is damaged in shipping, the damaged freight often needs to be remediated before it can be delivered or redelivered. The trucker typically needs to wait for a distribution center to assign a new delivery time slot, usually 24-48 hours past their original delivery window. Costs are incurred with each delay and at each step of the process. With a damaged load in the trailer, truckers cannot proceed to their next assignment until the damaged load had been remediated and delivered.

Additionally, arranging for freight remediation is not straightforward. Third-party logistics companies (3PLs) or shippers typically locate service agents to remediate problems on a case-by-case basis. One approach that third-party logistics companies or shippers often use is to input Google search terms to identify service agents for various services and then contact those agents directly. Third-party logistics companies or shippers using this method maintain their own hard copy lists of such agents. Such lists are unique to each individual third-party logistics company or shipper, need to be updated via the same process, and are limited in scope. When service is required in new locations, the third-party logistics company or shipper typically must use the same Google search method to identify new service providers. This can be a time-consuming process.

Third-party logistics companies or shippers can also access online directories of transportation and freight shipping companies to search for warehousing or other services by location or type of service. Such directories are often static lists that include company name, contact information, services provided, ratings, and sometimes links to transportation company websites. Though some lists are free, others require a fee for the company name to be included in the directory. Examples of some online directories include americatrucking.com, fleetdirectory.com, and 3plfinder.com.

Third-party logistics companies or shippers can also access a subscription service to receive online and hard copy directories from a service such as leonardsguide.com. Annual subscriptions to the online directories and hard copy directories offered by such sites are relatively expensive.

There are clear drawbacks to each of these approaches. First, each of these is simply a list that may contain inaccurate or out-of-date information as the directory may be updated only when the listing is renewed. Second, the directory may not list all of the service agents in a given area. The directory may only list those service agents that have paid for a listing or have placed advertisements on the website.

With any given load, there are typically multiple parties-3PL, shipper, freight broker, carrier, and individual trucker—involved in each transaction, and it was not always clear who had the authority to make decisions regarding freight remediation. Often multiple parties arranged for freight remediation for the same load, creating confusion, communication problems, and more potential delays. As a result, freight remediation is highly inefficient due to the lack of a standardized or automated process.

### SUMMARY

In an embodiment, the presently disclosed system and method provides an integrated Internet website and mobile applet platform for the on-demand provisioning of freight remediation services including freight rework, repacking, cross docking, and redelivery. Through its software platform, the presently disclosed system and method mediates service configuration, service pricing, and service facility selection between its clients and service agents.

In an embodiment, the presently disclosed website and mobile app platform include a service agent facility that allows automated scheduling for freight remediation services to third-party logistics companies or shippers. This eliminates the need for third-party logistics companies or shippers to search for service agents via phone or Internet and saves them both time and money. Based on the freight location, clients can use the facility locator to locate and select the most appropriate service agent depending on distance, direction or services to be performed. Once a client has selected a service facility, the platform provides immediate directions to that facility via the automated facility locator and sends a message to the service facility to accept or reject the freight remediation order.

In an embodiment, the presently disclosed system and method provide an automated and standardized process for locating, estimating, scheduling and billing freight remediation services across the continental United States. The system and method can provide one-stop service for locating a service agent, configuring work, estimating cost, and tracking work in progress through uploaded photos and comments. Its standardized nationwide pricing for freight remediation services provides cost transparency to 3PLs or shippers and service agents. In addition, all information regarding freight remediation orders is maintained on the site using the 3PL BOL or shipper reference number, thus making it easy for clients to track both current and closed freight remediation orders.

In an embodiment, the presently disclosed website and mobile app platform allows clients to enter a detailed description of the freight that needs to be remediated. This provides a record for the service agent to understand the problem with the freight and reduces miscommunications common in phone conversations. Additional freight services such as cross docking and redelivery can also be configured and scheduled via the platform. In the case of cross docking, the platform allows for the length of cross docking to be entered. In the case of redelivery, the platform allows for the redelivery distance to be entered.

The platform can include a freight remediation cost estimator that offers standardized nationwide pricing for freight remediation services. Pricing can be automatically calculated via the work estimator in the platform, which provides cost transparency to third-party logistics companies or shippers and service agents. This module generates an estimated cost detail for the rework. In addition, this module includes a photo and comment input module that captures photo uploads and work descriptions so that rework pricing and authorization can be done in a matter of minutes. Via this module, third-party logistics companies and shippers can monitor the status of their repair without calling the service center, saving both time and money.

The presently disclosed website and mobile app platform provide a record of messages sent between clients and services and an archive of both open and completed rework orders.

By remediating damaged loads, the presently disclosed system and method reduces claims processing and insurance expense for third-party logistics companies and shippers.

In addition, service agent records, Certificates of Insurance (COI) and contracts can be stored via the platform for easy access.

The system can be configured to offer a series of training videos on how to register for an account, use the applet, and open new cases on the applet and the website. These videos can be stored and accessed in the platform.

In an embodiment, the presently disclosed system and method can accept a variety of payment methods in accordance with transportation industry standards including PayPal, Credit Card, ACH, Comchek and Tcheck. It can also offer a streamlined registration process through t website. Client third-party logistics companies and shippers register once, and member service agents are instantly available to them with no additional carrier or broker paperwork.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 shows a page of a website from which a user can register as an Agent or Broker/3PLS.

FIG. 2 shows an example of a user registration page for a Broker/3PLS.

FIG. 3 shows an example of a user registration page for an agent.

FIG. 4 shows an example of a home page of a website where a user can login as an Agent or Broker/3PLS.

FIG. 5 shows an example of a login page for a Mobile Application where a user can login as an Agent or Broker/3PLS.

FIG. 6 shows an example of a Forgot Password page of the website.

FIG. 7 shows an example of a Dashboard page for a Broker/3PLS.

FIG. 8 shows an example of a Dashboard of a Mobile Application for the Broker/3PLS.

FIG. 9 shows an example of a Dashboard of the website for an Agent.

FIG. 10 shows an example of a Dashboard of a Mobile Application for the Agent.

FIG. 11 shows an example of a Create New Freight web page.

FIG. 12 shows an example of a Create New Freight mobile app page.

FIG. 13 shows an example of a Set Freight Location page.

FIG. 14 shows an example of a Select Facility page.

FIG. 15 shows an example of a map view page.

FIG. 16 shows an example of a Select Facilities page in a mobile app.

FIG. 17 shows an example of a Select Cross-Dock Facility web page.

FIG. 18 shows an example of a Select Cross-Dock Facility page in a mobile app.

FIG. 19 shows an example of a Select Redelivery Facility page.

FIG. 20 shows an example of a web page for uploading images of freight.

FIG. 21 shows an example of a page in a mobile app for uploading images of freight.

FIG. 22 shows an example of an estimate detail web page.

FIG. 23 shows an example of an estimate detail page in a mobile app.

FIG. 24 shows an example of a page for viewing open cases.

FIG. 25 shows an example of a page for editing open cases.

FIG. 26 shows an example of a page for viewing and editing open cases in a mobile app.

FIG. 27 shows an example of a page for logging in as an agent from a website.

FIG. 28 shows an example of a page for logging in as an agent from a mobile app.

FIG. 29 shows an example of a page for viewing messages from a website.

FIG. 30 shows an example of a page for viewing messages from a mobile app.

FIG. 31 shows an example of a page for sending requests in messages.

FIG. 32 shows an example of a page for viewing freight details.

FIG. 33 shows an example of a page that allows a Broker/3PL to get directions.

FIG. 34 shows an example of a page that allows a Broker/3PL to view freight requests sent in Messages.

FIG. 35 shows an example of a page that shows detail of a request sent in a Message.

FIG. 36 shows an example of a page that results from clicking on a Get Direction map view button.

FIG. 37 shows an example of a web page that results from changing the status of freight to ‘invoice confirmed’.

FIG. 38 shows an example of a page that displays an invoice.

FIG. 39 shows an example of a mobile app page that results from changing the status of freight to ‘invoice confirmed’.

FIG. 40 shows examples of pages of a mobile app which allow viewing details of completed freight and the invoice associated therewith.

### DETAILED DESCRIPTION

Reference will now be made in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

In an embodiment, a system for on-demand provisioning of freight remediation services including freight rework, repacking, cross-docking and redelivery includes a data store having therein a freight remediation case database. A computer processor coupled to the data store and in communication through the Internet with a user device is programmed, upon receiving requests from the user device, to serve the user device data comprising instructions for populating one or more freight remediation case input pages and instructions for populating a dashboard page. The freight remediation case input pages include a user interface that prompts the user to create a new freight, enter or select a location for the new freight, select a facility for remediation of the new freight, select a cross-dock option for the new freight, enter or select a redelivery facility for the new freight, and open a case by accepting terms for freight remediation service. By remediating damaged loads, the presently disclosed system and method reduces claims processing and insurance expense for third-party logistics companies and shippers. The dashboard page includes a user interface that displays to the user data associated with one or more open cases.

In an embodiment, a system and method are provided that incorporate iOS, Android and a Website platform, integrating Google Maps API, SMS, Email, and a Payment Gateway (PayPal). The solution allows truckers and trucker agents to identify, track and facilitate the resolution of damaged freight during the trucking delivery process.

Truckers and/or trucker agents use the mobile application to create and/or open a ‘damaged freight’ incident/case by inputting detailed information into the mobile application, defining the type of damage (with photo images). The ‘damaged freight’ case information is sent via a mobile device to the website to communicate the damage to an agent and/or facility which facilitates the repair of the damaged freight. The mobile/website solution provides available facility names, locations, and directions to the trucker/agent creating the open case for damaged freight. In an embodiment, the website also allows the processing of invoices to pay for the services provided by the facility for fixing the damaged freight. In an embodiment, all information in regard to users, agents, facilities, facility locations, and damages, are stored in a freight remediation case database, which may be a cloud database (e.g., AWS Cloud). The case database may be used for administrative review and statistical purposes.

The presently disclosed system and method, in an embodiment, provides a full 360 automated method for identifying damaged freight, tracking and storing damaged freight information, communicating damaged freight information, and facilitating invoices and payments associated with fixing damaged freight.

The system may be implemented using the following platforms: iOS (All iPhone Devices, iOS Tablets, and iOS operating systems); Android (All Android Devices, and Android Tablets and Android operating systems); Website (PC, MAC)—Chrome, Fox, Safari, Internet Explorer; AWS Cloud Database/Server; Google Maps API; PayPal Payment Gateway API; Email Server. Additionally, the system may be implemented using the following software: Objective C; Java, C++; HTML; MySQL; RestFUL.

The application features and flow will now be described.

Registration:

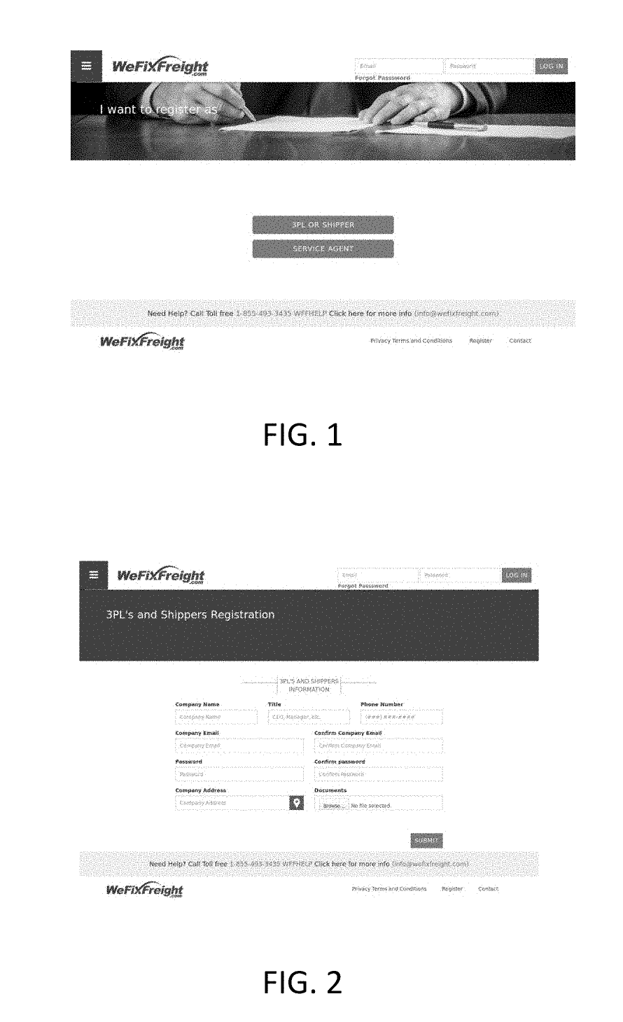

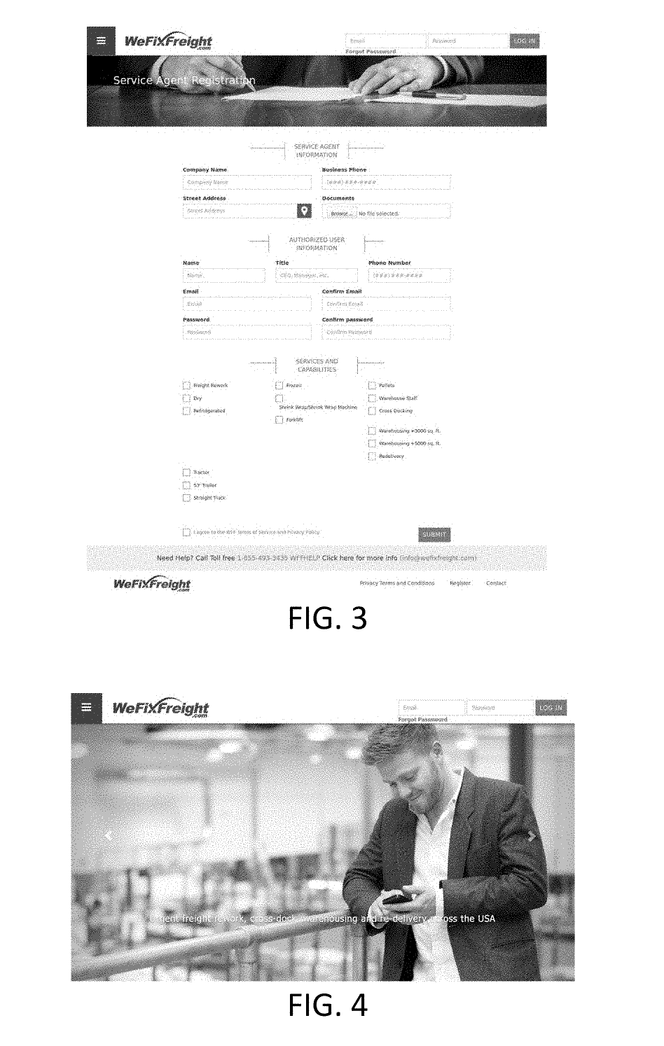

FIG. 1 shows a page of a website from which a user can register as an Agent or Broker/3PLS. FIG. 2 shows an example of a user registration page for a Broker/3PLS. FIG. 3 shows an example of a user registration page for an agent.

Login Screen

FIG. 4 shows an example of a home page of a website where a user can login as an Agent or Broker/3PLS, along with the administrator of the application/website.

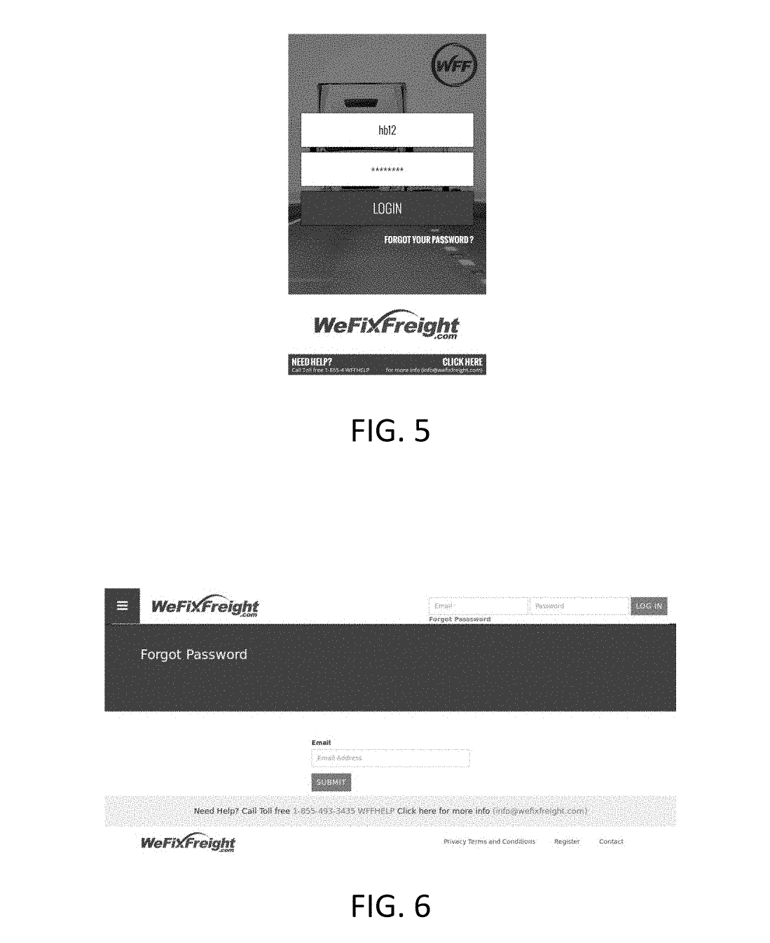

FIG. 5 shows an example of a login page for the Mobile Application where a user can login as an Agent or Broker/3PLS.

Forgot Password

FIG. 6 shows an example of a Forgot Password page of the website where a user can enter an email ID and click on the submit button. The ‘forgot password’ link will be sent to the users email address. From here, the user can reset and create a new password.

Dashboard:

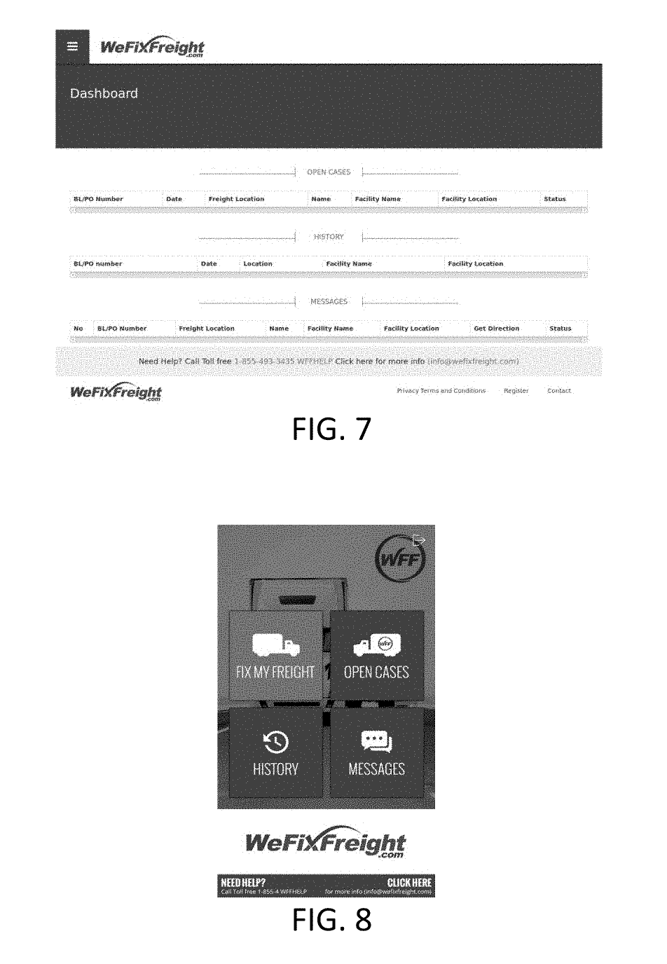

FIG. 7 shows an example of a Dashboard page for the Broker/3PLS. From the Dashboard page, the user can view his/her open cases, History, Messages and also can set his/her new freight.

FIG. 8 shows an example of a Dashboard of the Mobile Application for the Broker/3PLS. From the Dashboard screen, the user can view their open cases, History, Messages and also can set his/her new freight.

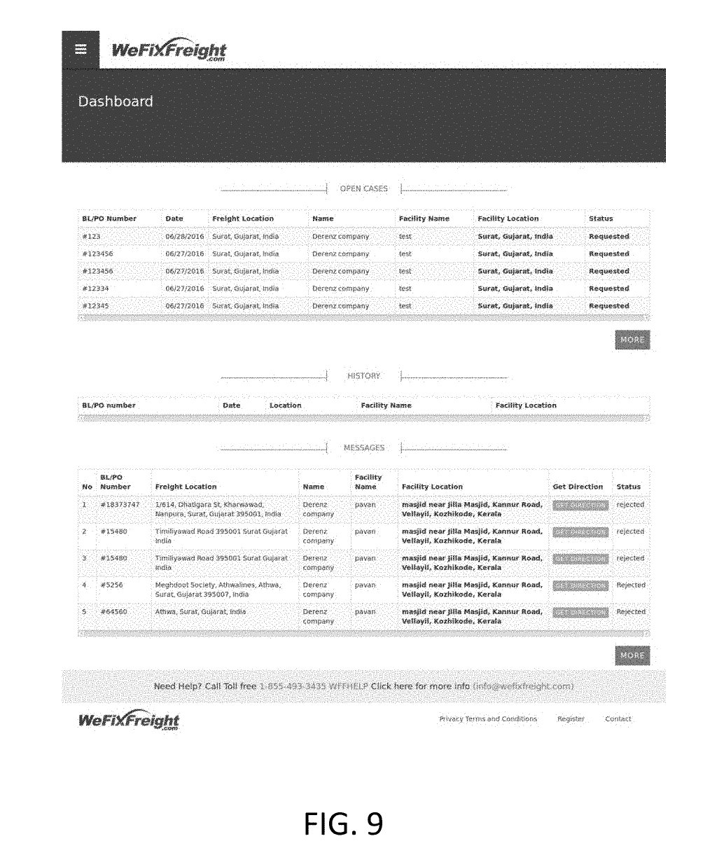

FIG. 9 shows an example of a Dashboard of the website for an Agent. From the Dashboard screen, a user can view open cases, History, and Messages.

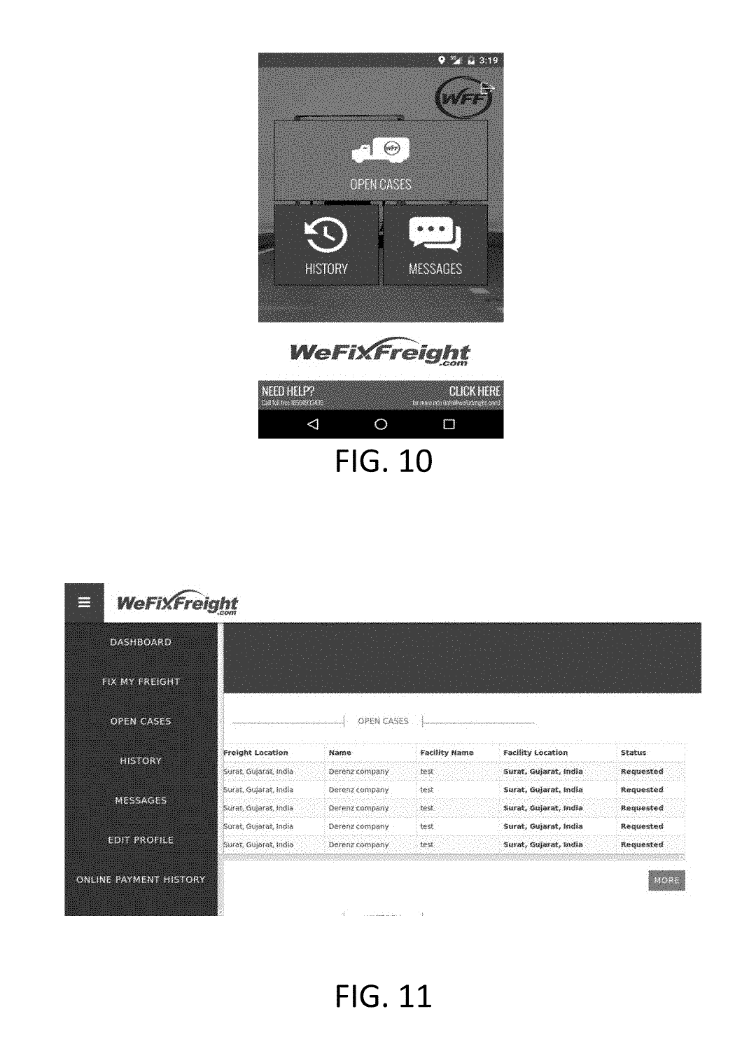

FIG. 10 shows an example of a Dashboard of a Mobile Application for the Agent. From Dashboard, users can view his/her open cases, History, and Messages.

Fix My Freight:

Step 1: Create a New Freight

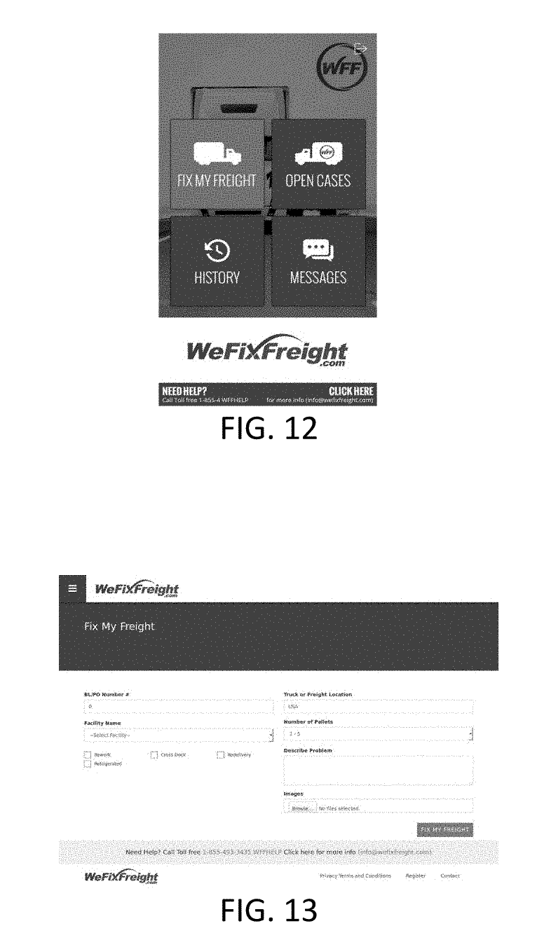

As shown in FIG. 11, to create a new freight form from the website, the Broker/3PLS clicks on the the “Fix My Freight” option from the left slide menu. As shown in FIG. 12, to create a new freight form from the Mobile Application, the Broker/3PLS has to click on “Fix My Freight” option from dashboard.

Step 2: Set Freight Location

As shown in FIG. 13, from the website, a Broker/3PLS can select a truck or freight location. The truck or freight location field is necessary to select a facility option to identify the nearest facility.

From the Mobile Application, the Broker/3PLS can select truck or freight location. The Broker/3PLS can set his/her current location by clicking on the Marker icon.

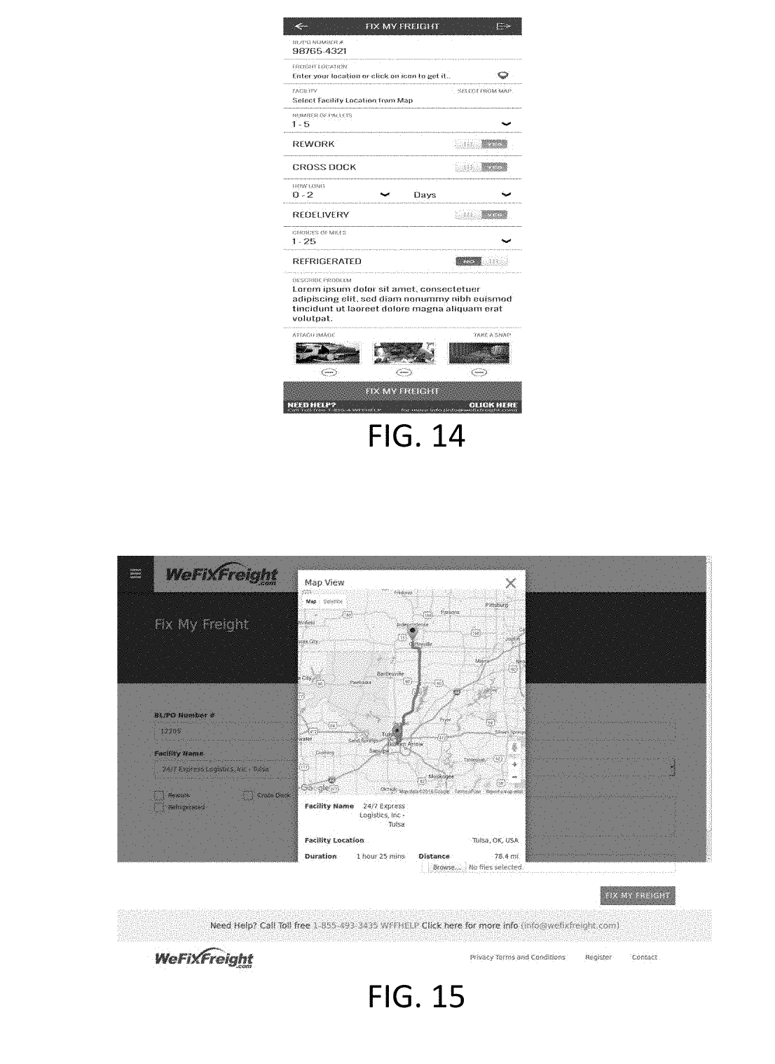

As shown in FIG. 14, the truck or freight location field is used to select a facility option to identify the nearest facility.

Step 3: Select Facility

From the website, the Broker/3PLS can view facilities in a dropdown format.

After selecting a location from the dropdown, a Marker option will be enabled by clicking on the icon Map view in the popup.

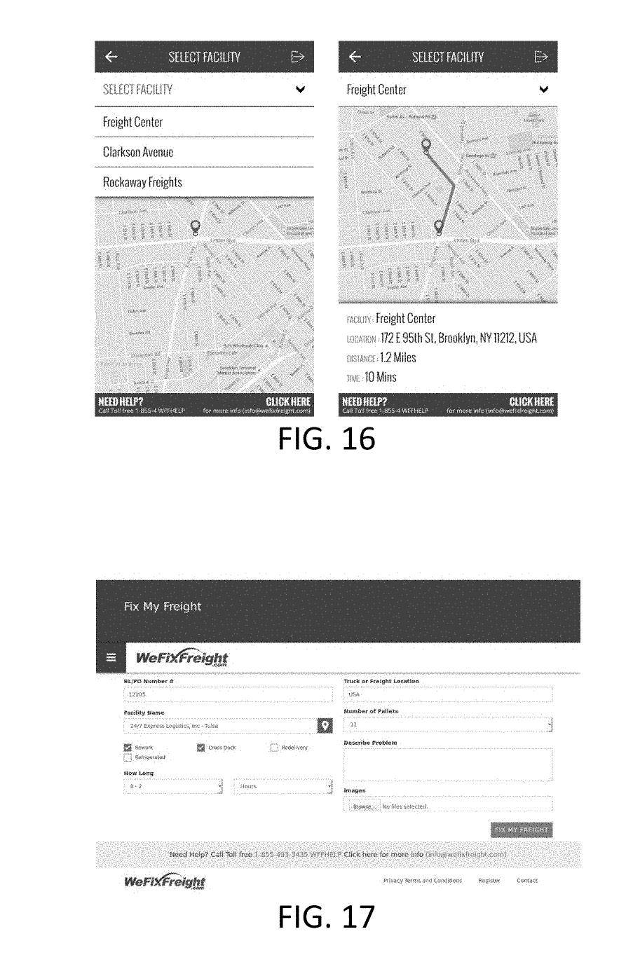

On the map view, the freight location and facility location can be viewed. As shown in FIG. 15, the first pin is the ‘my freight’ location and the second pin defines the selected facility location. Users can view the time, duration, and distance.

As shown in FIG. 16, from the mobile application, the Broker/3PLS can view facilities in a dropdown format. After selecting a location from the dropdown, a Marker option will be enabled by clicking on the icon Map view in the popup. On the map view, the freight location and facility location can be viewed. The first pin is the ‘my freight’ location and the second pin defines the selected facility location. Users can view the time, duration, and distance.

Step 4: Select Cross-Dock Facility

As shown in FIG. 17, from the website, the Broker/3PLS can select a Cross-Dock option and set the duration of time he/she wants for this service. As shown in FIG. 18, from Mobile Application, the Broker/3PL can do the same thing by selecting yes/no Cross-Dock.

Step 5: Select Redelivery Facility

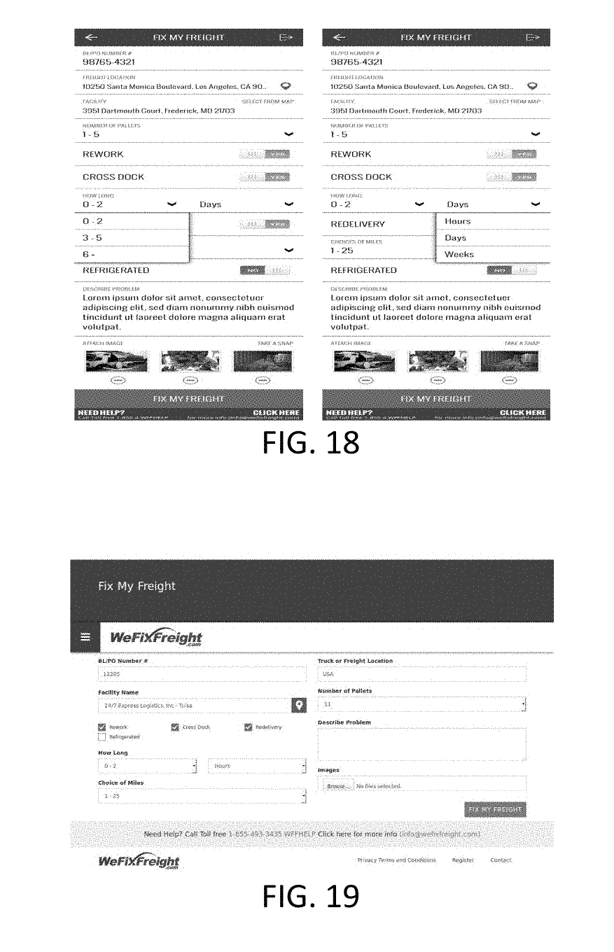

As shown in FIG. 19, from the website, the Broker/3PLS can select the Cross-Dock option, then he/she can set the amount of miles he/she wants for this service. From Mobile Application Broker/3PL can do the same thing by selecting yes/no Redelivery option.

Step 6: Submit Form

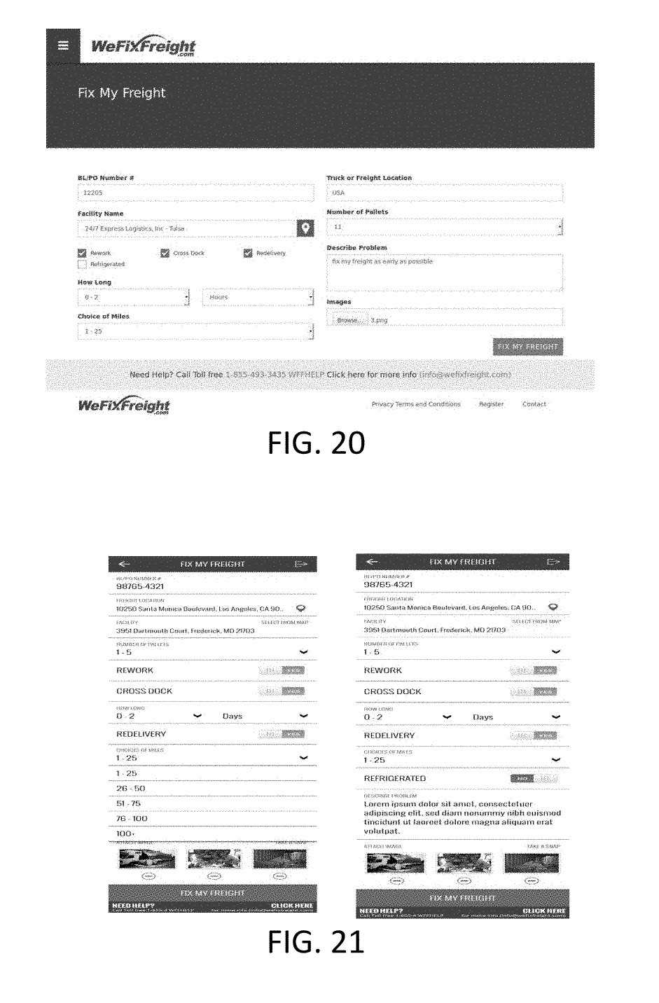

As shown in FIG. 20, from the website, a user can upload multiple images of the freight to fix. After filling in all the details, the Broker/3PLS can submit it. As shown in FIG. 21, from the Mobile Application, the Broker/3PL can accomplish the same.

Step 7: Estimate Detail

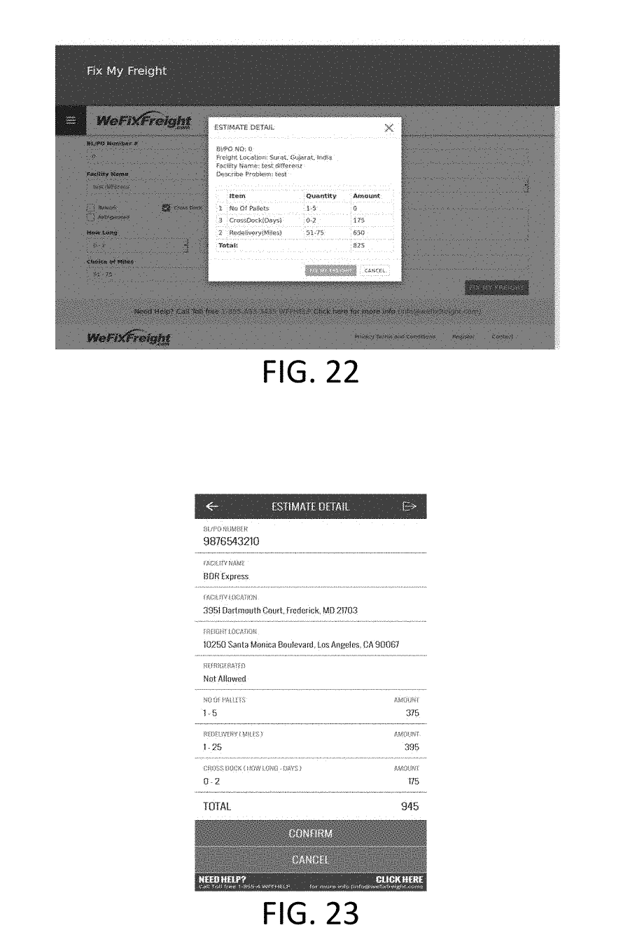

As shown in FIG. 22, from the website, when a Broker/3PL clicks the Fix my freight button, an estimate with detail will be shown that contains the estimated amount to fix the freight. The Broker/3PL can move forward with having the freight fixed or cancel the case. If the Broker/3PL chooses to fix the freight, then the information will show in open cases of the Broker/3PL, and the information will be sent to Agents as a request. FIG. 23 illustrates the estimate detail in the Mobile Application.

Step 8: View Freight

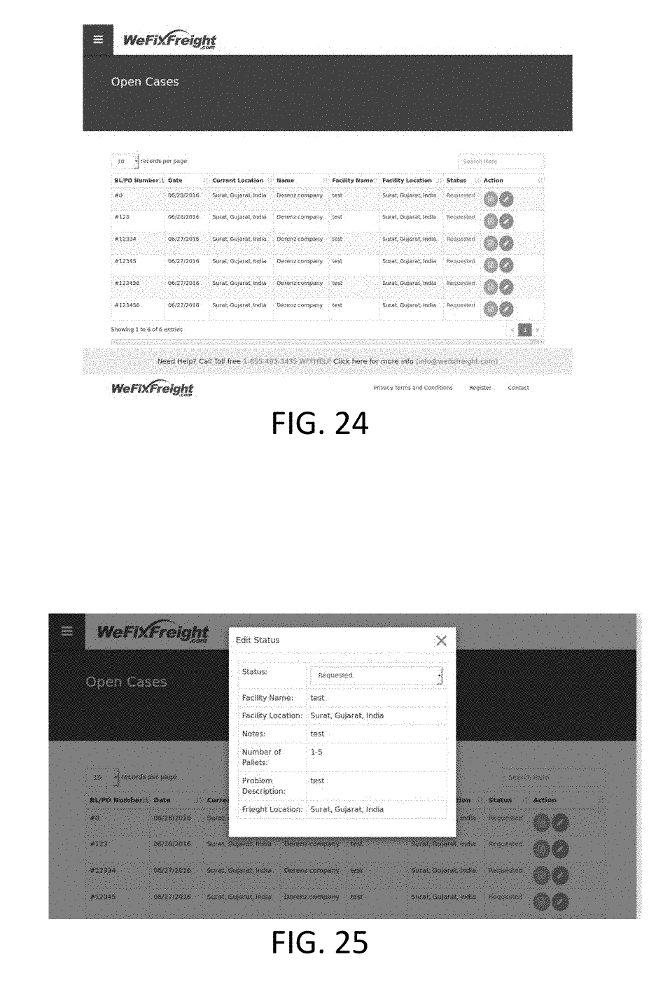

As shown in FIG. 24, from the website, the Broker/3PL can view all of the freight (not Completed) in Open Cases. The Broker/3PL can view two options (Edit and View freight) in the action column. The Invoice option is only for Invoice Confirmed Freight. By clicking on the view button, the Broker/3PL can view the freight detail. As shown in FIG. 25, if the user clicks on the edit button, there are three to seven steps to update the freight case.

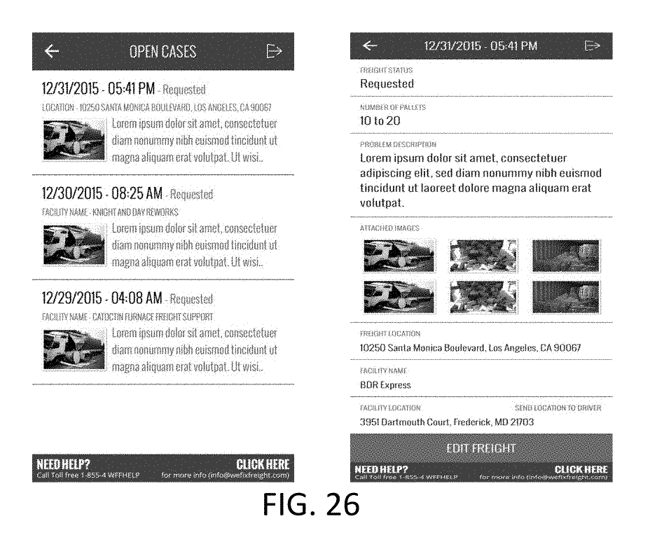

As shown in FIG. 26, from the Mobile Application, the Broker/3PL can view all of the freight (not Completed) in Open Cases. By clicking any item from the list, the Broker/3PL can view the details of his/her freight and update it accordingly. If the user clicks on the edit button, there are three to seven steps to update the freight case.

Step 9: Logout and Login as Agent to Accept or Reject Freight and Update the Status of Freight

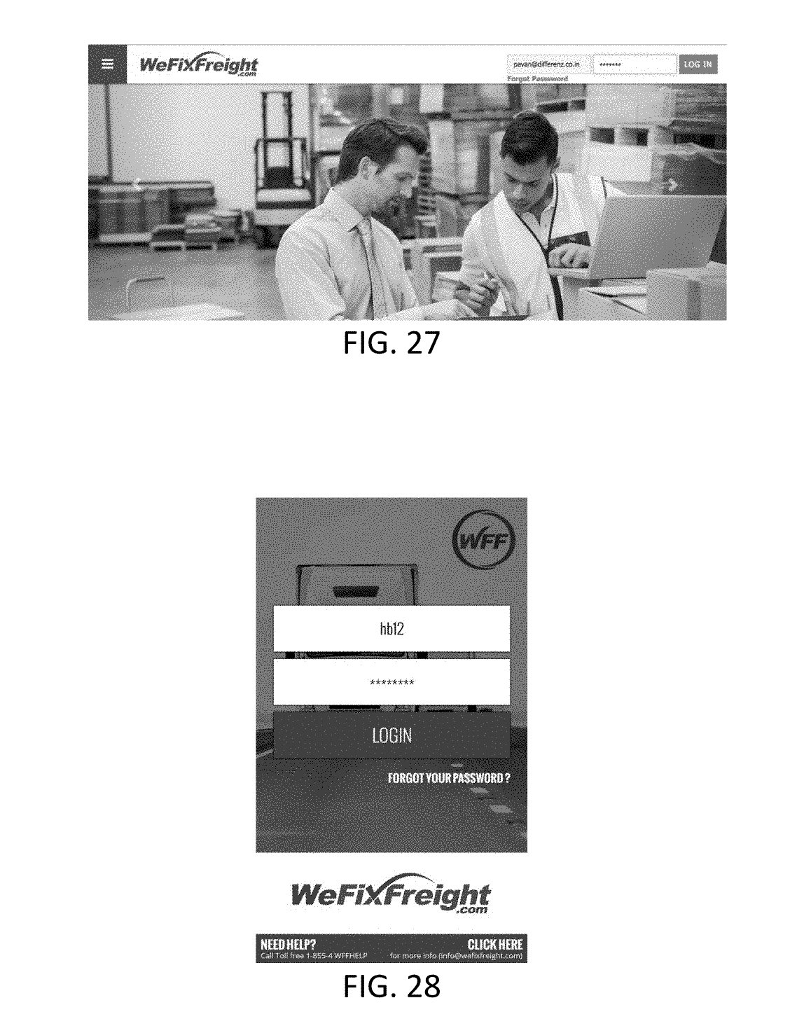

The user logs in as Agent from the website (FIG. 27) or the Mobile application (FIG. 28) to accept or reject freight.

Step 10: Go to Messages

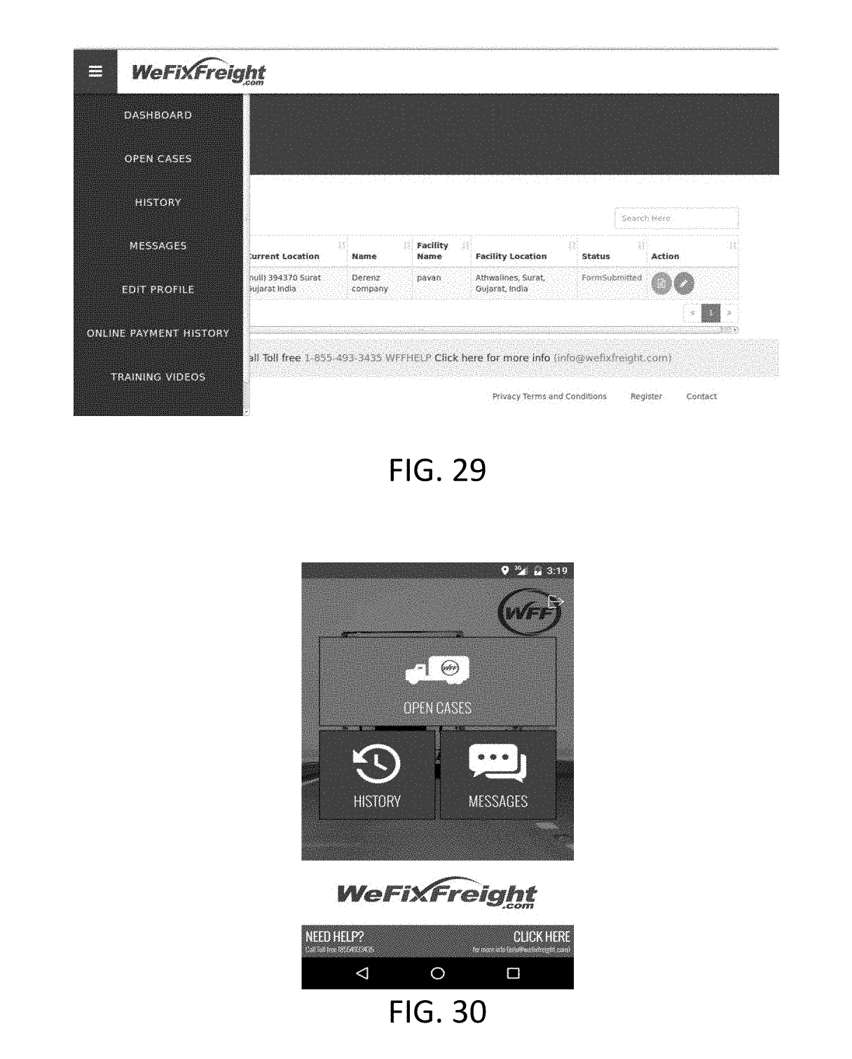

As shown in FIG. 29, to view messages from the website, the Agent clicks on the “MESSAGES” option from slide menu. As shown in FIG. 30, the same can be done from the Mobile application.

Step 11: Requests in Messages

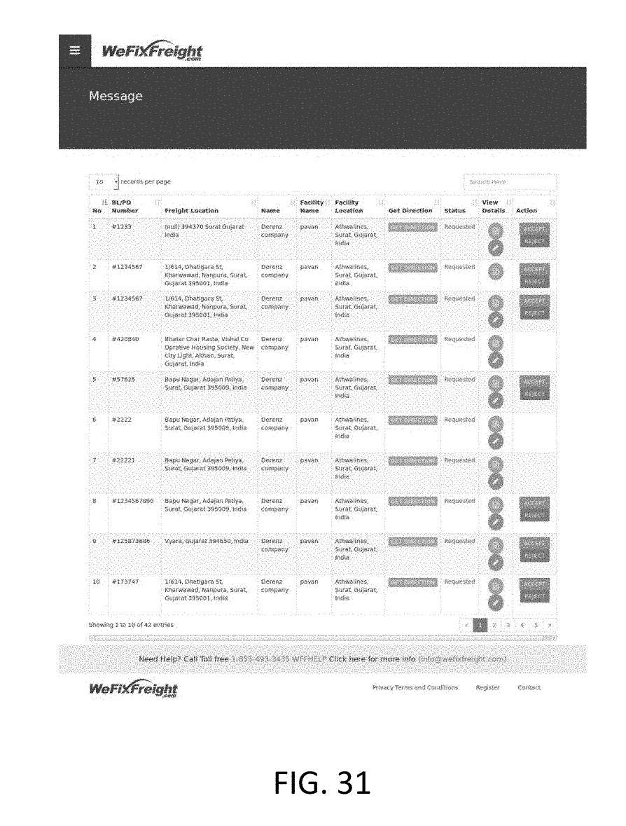

As shown in FIG. 31, from the website, when the Broker submits a fix my freight form, it will be go into the agent's messages for approval. The Agent has 3 options (Accept, Reject, Edit) for approval. Agent can also view the detail of freight and update it.

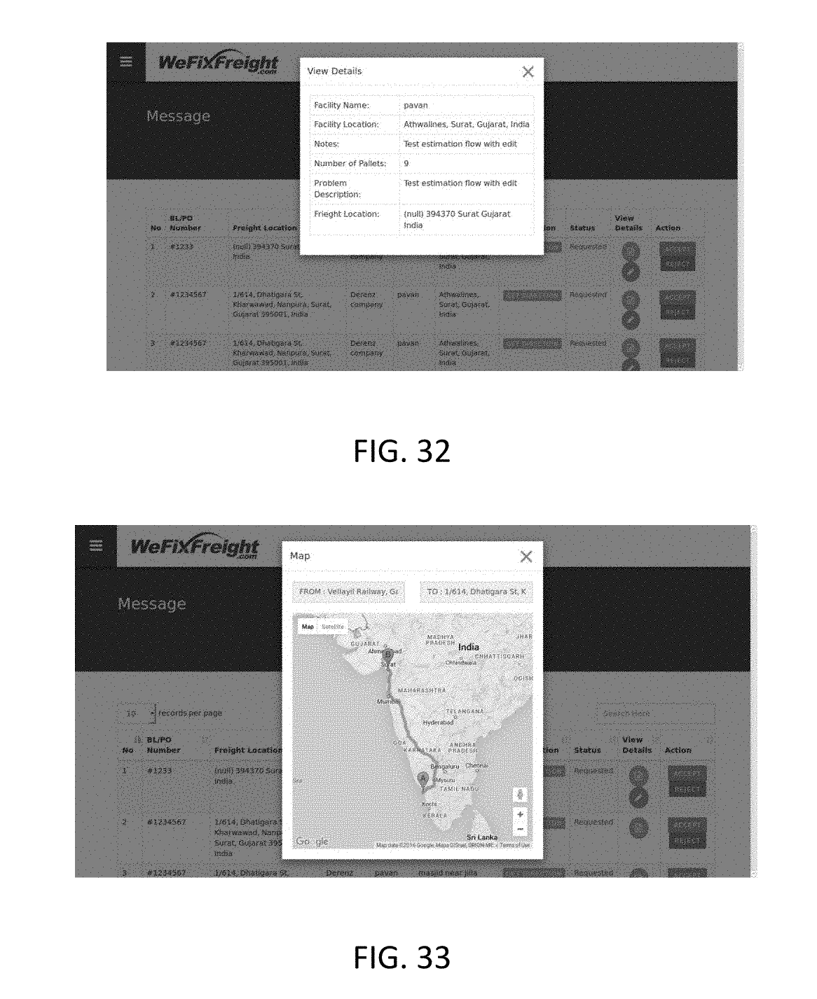

As shown in FIG. 32, by clicking on the view button, the Broker/3PL can view his/her freight details.

As shown in FIG. 33, by clicking on the get directions button, the Agent can view directions from the freight location to the facility location.

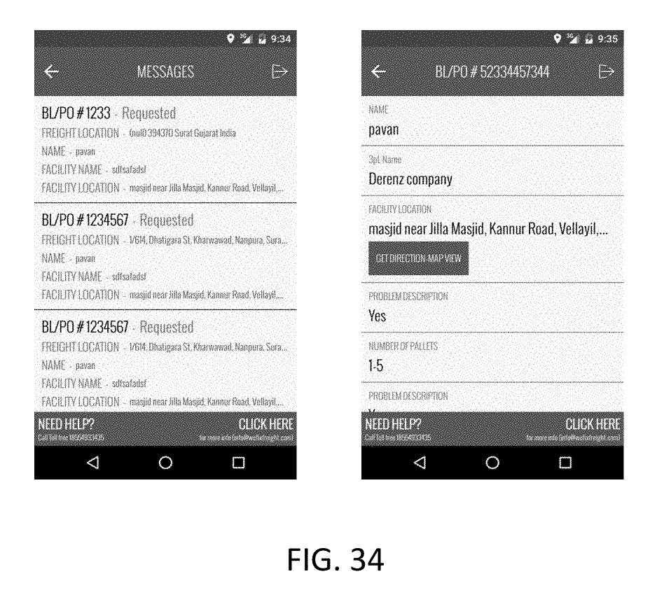

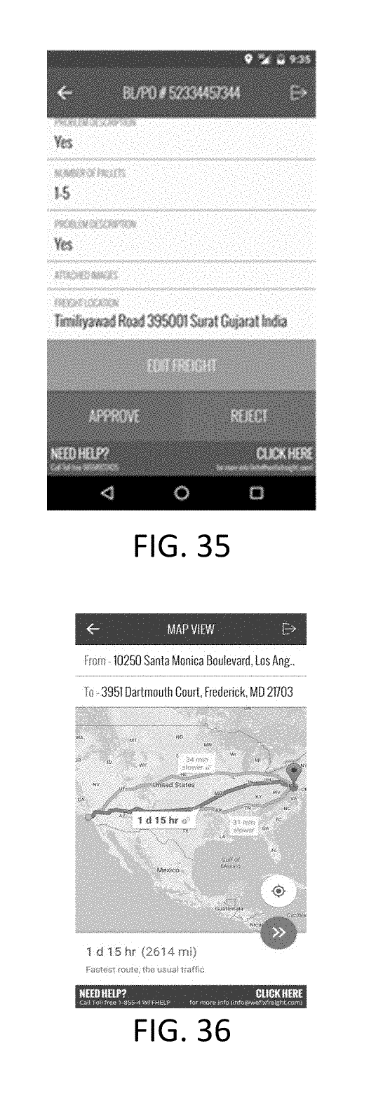

As shown in FIG. 34, from Mobile Application Agent can see all freight requests sent by Broker/3PL in Messages. As shown in FIG. 35, by clicking any item from list Agent can see the details of its freight and can accept, reject or edit the freight.

As shown in FIG. 36, by clicking on the Get Direction map view button, the Agent can view the directions from the freight location to the facility location. It shows multiple routes to get to the facility, however the blue line path is the fastest route with the usual traffic, and also shows how much time it takes to get to the Freight location.

Step 12: Change Status to Invoice Confirmed

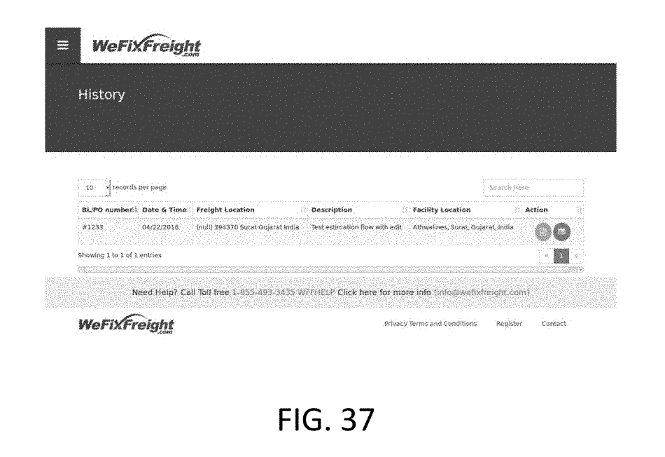

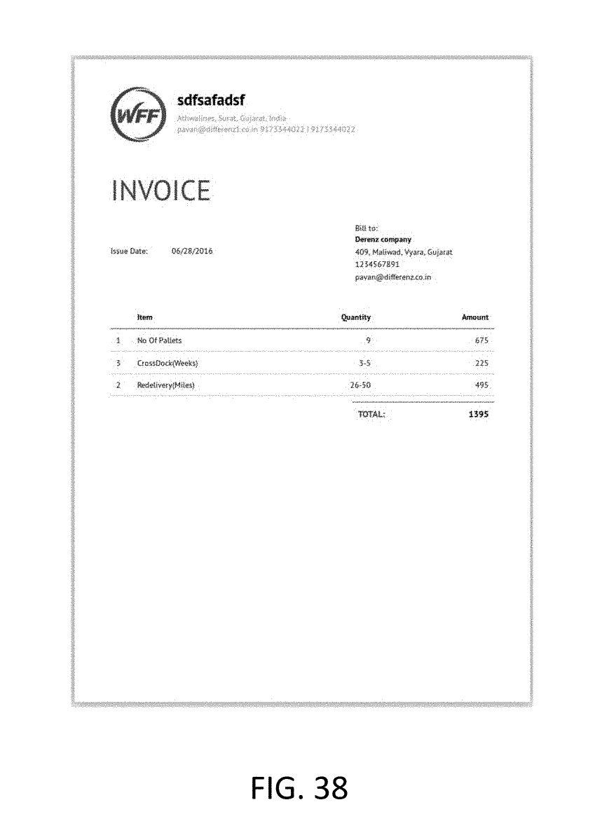

As shown in FIG. 37, from the website, when the Agent changes the status of the freight to ‘invoice confirmed’, then the fixing of the freight will be completed, and the Invoice is sent to the Broker in email and the freight information is stored in the application history for the Agent's or Broker/3PL's.

As shown in FIG. 38, from the history, the Broker/3PL or agent can view the invoice.

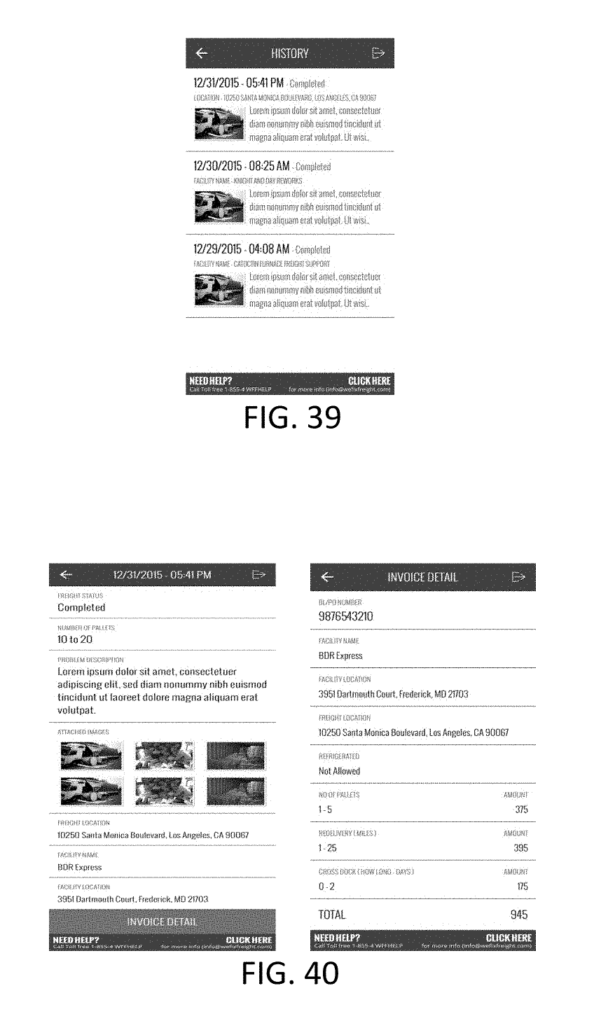

As shown in FIG. 39, from the Mobile Application, when the Agent changes the status of the freights to ‘invoice confirmed’, then the fixing of the freight will be completed, and the Invoice is sent to the Broker in an email and the freight information is stored in the application history for the Agent's or Broker/3PL's.

As shown in FIG. 40, by clicking any item from the Agent or Broker/3PL list, the user can view the details of his/her completed freight. By clicking the invoice detail button, the Agent or Broker/3PL can view the invoice detail.

One extension of the above-described technology is to use it for other transportation related services. Such services may include, but are not limited to, remediation services for refrigerated freight or lumping service for freight bound to multiple destinations. Lumping includes unloading, unpacking, breaking down a load, repacking the load in smaller configurations, reloading, and staging the reconfigured freight to multiple destinations. Other possible freight related services include container stripping and rework, repairing damaged rail cars, providing intermodal services for containers, and when available, offering heavy weight drone services.

In an embodiment, the system maintains a freight history for all clients, which allows for analytics to be conducted on a variety of data and identify patterns for major shippers and 3PLs and industry trends. For example, the technology may be used to analyze which shippers have routine problems with their freight being packed properly. Additionally, the data could reveal if distribution centers are rejecting freight with actual damage or are using freight rejection for inventory control purposes. Such data allows for all parties involved in the transaction to streamline their systems and reduce costs associated with freight remediation.

In an embodiment, the system is provided with an API structure that allows it to extend its functionality to other websites and to various TMS (Transportation Management Systems) software platforms. These TMS are used by brokers and shippers to originate loads, contract them out, and to manage them from origination through delivery. The system can be configured to serve as a remediation option residing on the TMS desktop, or as an extension of load board websites.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described above with reference to operational illustrations of methods and devices for providing freight remediation service. It is understood that each operation described may be implemented by means of analog or digital hardware and computer program instructions stored in a data store in communication with a processor, the processor being in communication over the internet with a user device such as a smart phone that runs an app or a computing device running a browser. In some cases, the program instructions for a particular operation are run on the user device. The computer program instructions may be stored on computer-readable media and provided to a processor of a general-purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

At least some aspects disclosed can be embodied, at least in part, in software. That is, the techniques may be carried out in a special purpose or general-purpose computer system or other data processing system in response to its processor, such as a microprocessor, executing sequences of instructions contained in a memory, such as ROM, volatile RAM, non-volatile memory, cache or a remote storage device. Functions expressed in the claims may be performed by a processor in combination with memory storing code and should not be interpreted as means-plus-function limitations.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

As used herein, and especially within the claims, ordinal terms such as first and second are not intended, in and of themselves, to imply sequence, time or uniqueness, but rather are used to distinguish one claimed construct from another. In some uses where the context dictates, these terms may imply that the first and second are unique. For example, where an event occurs at a first time, and another event occurs at a second time, there is no intended implication that the first time occurs before the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristic.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

What is claimed is:

1. A system for on-demand provisioning of freight remediation services including freight rework, repacking, cross-docking and redelivery, comprising:
a) a data store including a freight remediation case database; and
b) a computer processor coupled to the data store and in communication through the Internet with a user device and programmed, upon receiving requests from the user device, to serve data to the user device, the data comprising:
i) instructions for populating one or more freight remediation case input pages having a user interface that prompts the user to create a new freight, enter or select a location for the new freight, select a facility for remediation of the new freight, select a cross-dock option for the new freight, enter or select a redelivery facility for the new freight, and open a case by accepting terms for freight remediation service; and,
ii) instructions for populating a dashboard page having a user interface that displays to the user data associated with one or more open cases.

2. The system for on-demand provisioning of freight remediation services according to claim 1, wherein the data comprises data for populating a web page and the user device comprises a computing device running a web browser.

3. The system for on-demand provisioning of freight remediation services according to claim 1, wherein the data comprises data for populating a page in an app running on the user device.

4. The system for on-demand provisioning of freight remediation services according to claim 3, wherein the user device comprises a smart phone.

5. The system for on-demand provisioning of freight remediation services according to claim 1, wherein the data further comprises instructions for populating one or more estimate pages having a user interface that displays to the user one or more costs associated with freight remediation services selected in the freight remediation pages.

6. The system for on-demand provisioning of freight remediation services according to claim 5, wherein the processor is configured to open a case upon acceptance by the user of the one or more costs associated with the freight remediation services selected.

7. The system for on-demand provisioning of freight remediation services according to claim 1, wherein the database comprises a cloud database.

8. The system for on-demand provisioning of freight remediation services according to claim 1, wherein the processor is configured to mediate service configuration, service pricing, and service facility selection between clients and service agents.

9. The system for on-demand provisioning of freight remediation services according to claim 1, wherein the processor is further configured to perform analytics on data in the freight remediation case database to identify patterns associated with shippers.

10. The system for on-demand provisioning of freight remediation services according to claim 1, wherein the processor is further configured to perform analytics on data in the freight remediation case database to identify patterns associated with 3PLs.

11. The system for on-demand provisioning of freight remediation services according to claim 1, wherein the processor is further configured to perform analytics on data in the freight remediation case database to identify industry trends.

12. The system for on-demand provisioning of freight remediation services according to claim 1, wherein the processor is configured to schedule freight remediation services for one or more of said open cases.

13. The system for on-demand provisioning of freight remediation services according to claim 1, wherein the instructions for populating one or more freight remediation case input pages comprise facility location data that is based upon the freight location input or selected by the user.

14. The system for on-demand provisioning of freight remediation services according to claim 1, wherein the instructions for populating one or more freight remediation case input pages comprise instructions for displaying on the user device a map showing a route from a freight location to a selected facility location.

15. The system for on-demand provisioning of freight remediation services according to claim 1, wherein the instructions for populating one or more freight remediation case input pages comprise instructions for displaying on the user device a time or duration of time for travel from a freight location to a selected facility location.

16. The system for on-demand provisioning of freight remediation services according to claim 1, wherein the instructions for populating one or more freight remediation case input pages comprise instructions for displaying on the user device a distance for travel from a freight location to a selected facility location.

17. The system for on-demand provisioning of freight remediation services according to claim 1, wherein the instructions for populating one or more freight remediation case input pages comprise instructions for displaying on the user device directions for travel from a freight location to a selected facility location.

18. The system for on-demand provisioning of freight remediation services according to claim 1, wherein the instructions for populating one or more freight remediation case input pages comprise instructions for prompting the user to set a duration of time the user desires for a cross-dock service.

19. The system for on-demand provisioning of freight remediation services according to claim 1, wherein the instructions for populating one or more freight remediation case input pages comprise instructions for prompting the user to set an amount of miles the user desires for a cross-dock service.

20. The system for on-demand provisioning of freight remediation services according to claim 1, wherein the processor is further configured to send a message to a selected service facility to accept or reject a freight remediation order.
